(19) United States
(12) Patent Application Publication
(10) Pub. No.: US 2013/0262185 A1
(43) Pub. Date: Oct. 3, 2013

(54) Method and System for Differential Pricing in the Distribution of Digital Content

(71) Applicant: THE BOARD OF TRUSTEES OF THE LELAND STANFORD, JUNI, Palo Alto, CA (US)

(72) Inventor: Michael Genesereth, Palo Alto, CA (US)

(73) Assignee: The Board of Trustees of the Leland Stanford, Junior, University, Palo Alto, CA (US)

(21) Appl. No.: 13/632,360

(22) Filed: Oct. 1, 2012

Related U.S. Application Data
(60) Provisional application No. 61/618,826, filed on Apr. 1, 2012.

(51) Int. Cl. G06Q 30/02

(52) U.S. Cl. CPC G06Q 30/0206
USPC 705/7.35

(57) ABSTRACT

Among other things, the present invention provides an efficient rights management system that can accommodate complex licensing rules and differential pricing so as to be able to deliver digital media to a consumer at an efficient price, preferably a lowest price. For example, the present invention incorporates a price rules database that is able to keep track of various licensing term and their different pricing schemes that may be associated with a consumer so as to deliver digital content at an efficient price, preferably a lowest price.

### CROSS-REFERENCE TO RELATED APPLICATIONS

This application claims priority to U.S. Provisional Application No. 61/618,826 filed Apr. 1, 2012, which is hereby incorporated by reference in its entirety for all purposes.

### FIELD OF THE INVENTION

The present invention generally relates to the field of digital media. More particularly, the present invention relates to methods for the distribution of digital media over computer networks.

### BACKGROUND OF THE INVENTION

Modern computerized networks allow for the distribution of a wide array of digital media. In many ways, such computerized networks have made the distribution of digital media very efficient. In one important way, however, there continue to be inefficiencies.

More particularly, with so much digital media being available on computerized networks such as the Internet, there are likewise many copyright owners of such digital media. The owners of such media can make their digital content available on many different terms. Indeed, each content owner can have distinct terms but conventional systems have not been able to accommodate distinct and varied terms.

Modern distribution systems generally use broad schemes for handling the rights associated with digital media. In applying broad schemes, many of the details that individual copyright owners may want to apply to their digital works may, in the end, not be applied. A result is that a consumer of digital media may not receive the digital media under the lowest priced terms.

In certain situations, obstacles may exist in traditional mechanisms for content licensing that results in digital content being under-used. A user may potentially resort to extreme situations that may not be efficient. For example, a user that may desire certain digital content may resort to content providers that overcharge for such content, or a user may resort to piracy. Obstacles that can contribute to both of these situations include, for example, difficulty in locating the appropriate rightsholders, prohibitively high transaction costs involved in getting permission to use the desired content. In any case, the alternatives—overcharging or piracy—are less than optimally efficient.

Therefore, there is a need in the art for a rights management system that can apply many pricing and royalty schemes so as to deliver digital media and other content to a consumer under efficient terms.

### SUMMARY OF THE INVENTION

Among other things, the present invention provides an efficient rights management system that can accommodate complex licensing (e.g., royalty) rules, differential pricing, and personal preferences so as to be able to deliver digital media to a consumer at an efficient price, preferably a lowest price. For example, the present invention incorporates a price rules database that is able to keep track of various licensing term and their different pricing schemes that may be associated with a consumer so as to deliver digital content at an efficient price, preferably a lowest price.

Whereas prior art distribution schemes apply broad pricing schemes, the present invention is able to consider various options, including differential pricing schemes, to determine an efficient price, preferably lowest price, for an item of digital media. In an implementation, for example, a single publisher can have different prices for different customers. In an embodiment, a price rules database is maintained in conjuction with publishers' licensing terms to keep track of the different prices. In this way, the present invention is able to consider differential pricing, such as different prices under different terms or conditions.

An embodiment of the present invention is implemented as a web service that includes a copyright registry, a copyright marketplace exchange, and a copyright clearance engine. Among other things, the copyright registry provides for the ability of a user to identify copyright information about a desired work. Moreover, it provides information about the rights for the use of such work. Among other things, the copyright marketplace exchange provides a service through which users can buy, sell, or license copyrights and copyrighted works. The copyright clearance engine allows for connectivity to third-party distribution platforms that can deliver digital content to a user once digital rights have been properly managed according to embodiments of the present invention.

These and other embodiments can be more fully appreciated upon an understanding of the detailed description of the invention as disclosed below in conjunction with the attached figures.

### BRIEF DESCRIPTION OF THE DRAWINGS

The following drawings will be used to more fully describe embodiments of the present invention.

FIG. 1 is a block diagram of a computer system on which the present invention can be implemented.

FIG. 2 is a block diagram of a networked computer system on which the present invention can be implemented.

FIG. 3 is a block diagram of an embodiment of the present invention.

FIG. 4 is a block diagram illustrating the value chain for print academic content royalties.

FIG. 5 is a block diagram illustrating the value chain for digital academic content royalties.

FIG. 6 is a block diagram of a scenario in which an embodiment of the present invention can be implemented.

FIG. 7 is a block diagram of an embodiment of the present invention.

FIG. 8 is a block diagram of an embodiment of the present invention.

FIG. 9 is a flowchart of a method according to an embodiment of the present invention.

### DETAILED DESCRIPTION OF THE INVENTION

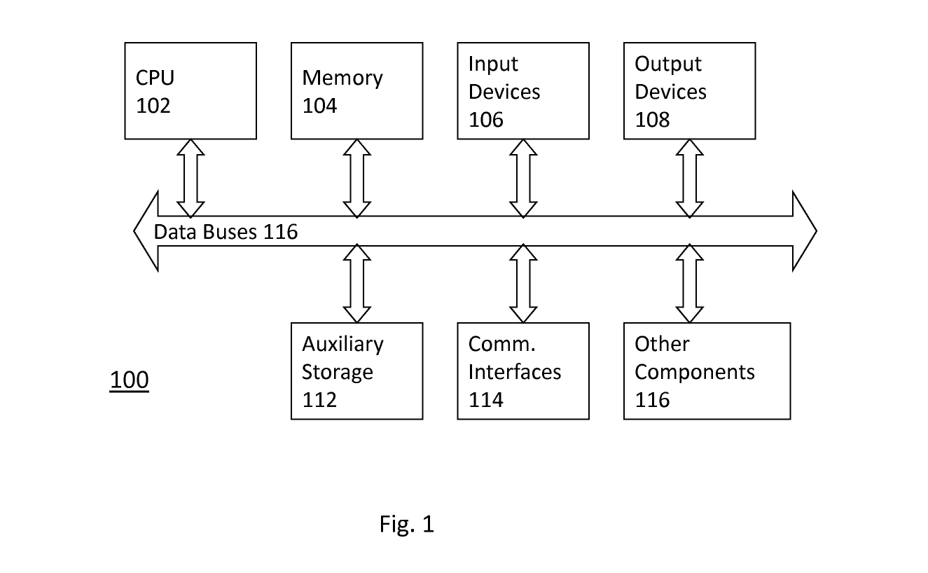

Among other things, the present invention relates to methods, techniques, and algorithms that are intended to be implemented in digital computer system 100 such as generally shown in FIG. 1. Such a digital computer or embedded device is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers or other digital devices such as mobile telephones or “smart” televisions as they become available.

Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the at would be familiar with such details.

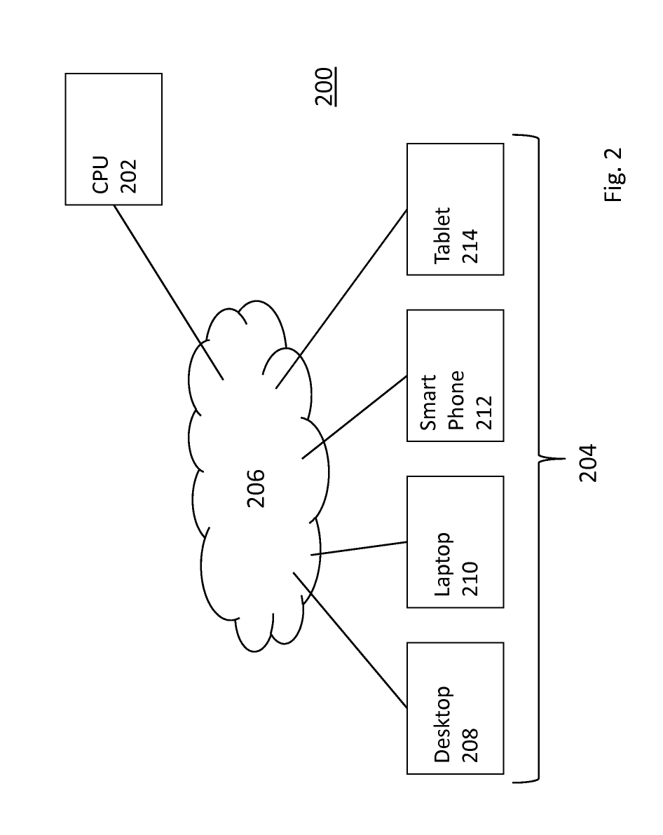

In an embodiment of the invention as shown in FIG. 2, a computer server that implements certain of the methods of the invention is remotely situated from a user. Computer server 202 is communicatively coupled so as to receive information from a user; likewise, computer server 202 is communicatively coupled so as to send information to a user. In an embodiment of the invention, the user uses user computing device 204 so as to access computer server 202 via network 206. Network 206 can be the internet, a local network, a private network, a public network, or any other appropriate network as may be appropriate to implement the invention as described herein.

User computing device 204 can be implemented in various forms such as desktop computer 208, laptop computer 210, smart phone 212, or tablet device 214. Other devices that may be developed and are capable of the computing actions described herein are also appropriate for use in conjunction with the present invention.

In the present disclosure, computing and other activities will be described as being conducted on either computer server 202 or user computing device 204. It should be understood, however, that many if not all of such activities may be reassigned from one to the other device while keeping within the present teachings. For example, for certain steps computations that may be described as being performed on computer server 202, a different embodiment may have such computations performed on user computing device 204.

In an embodiment of the invention, computer server 202 is implemented as a web server on which Apache HTTP web server software is run. Computer server 202 can also be implemented in other manners such as a Netscape Communications Corporation web server (known as Oracle iPlanet Web Server). In an embodiment computer server 202 is a UNIX-based machine but can also be implemented in other forms such as a Windows-based machine. Configured as a web server, computer server 202 is configured to serve web pages over network 206 such as the internet.

In an embodiment, user computing device 204 is configured so as to run web browser software. For example, where user computing device 204 is implemented as desktop computer 208 or laptop computer 210, currently available web browser software includes Internet Explorer, Firefox, and Chrome. Other browser software is available for different applications of user computing device 204. Still other software is expected to be developed in the future that is able to execute certain steps of the present invention.

In an embodiment, user computing device 204, through the use of appropriate software, queries computer server 202. Responsive to such query, computer server 202 provides information so as to display certain graphics and text on user computing device. In an embodiment, the information provided by computer server 202 is in the form of HTML that can be interpreted by and properly displayed on user computing device 204. Computer server 202 may provide other information that can be interpreted on user computing device.

Among other things, the present invention provides an efficient rights management system that can accommodate complex licensing rules and differential pricing so as to be able to deliver digital media to a consumer at an efficient price, preferably a lowest price. For example, the present invention incorporates a price rules database that is able to keep track of various licensing term and their different pricing schemes that may be associated with a consumer so as to deliver digital content at an efficient price, preferably a lowest price.

Whereas prior art distribution schemes apply broad pricing schemes, the present invention is able to consider various options, including differential pricing schemes, to determine an efficient price, preferably lowest price, for an item of digital media. In an implementation, for example, a single publisher can have different prices for different customers. In an embodiment, a price rules database is maintained in conjuction with publishers' licensing terms to keep track of the different prices. In this way, the present invention is able to consider differential pricing, such as different prices under different terms or conditions. Further details about these and other embodiments will now be provided.

An embodiment of the present invention is implemented as a web-based service for managing copyrights as will be described herein. For example, an embodiment of the present invention is implemented as a cloud-based system that assists users in accessing content at an economically efficient price (e.g., the lowest possible cost). Toward reaching an efficient price, an embodiment of the present invention can identify, for example, when the user has pre-existing rights to use content. Moreover, an embodiment can differentiate access and pricing accordingly.

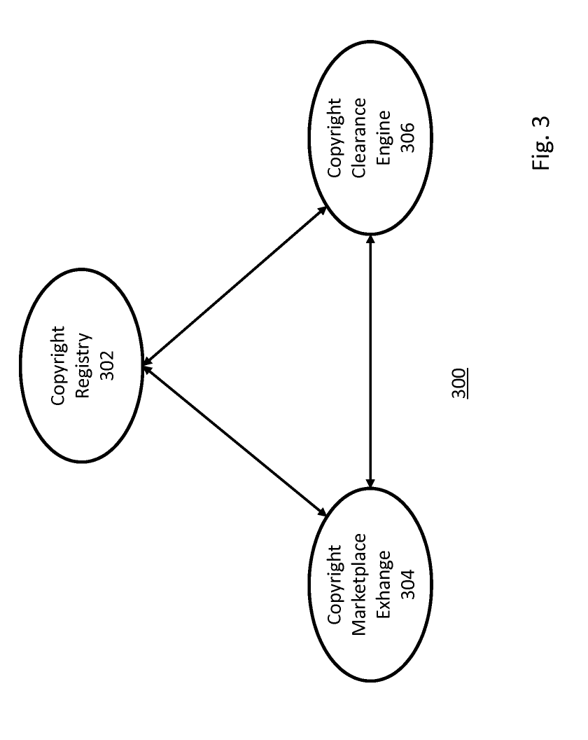

An embodiment of the present invention is implemented as copyright web service 300 as shown in FIG. 3 that includes, among other things, copyright registry 302, copyright marketplace exchange 304, and copyright clearance engine 306. Among other things, copyright registry 302 provides for the ability of a user to identify copyright information about a desired work. Moreover, it provides information about the rights for the use of such work. Among other things, copyright marketplace exchange 304 provides a service through which users can buy, sell, or license copyrights and copyrighted works. Copyright clearance engine 306, among other things, allows for connectivity to third-party distribution platforms that can deliver digital content to a user once digital rights have been properly managed according to embodiments of the present invention. Further details about copyright web service 300 will be provided below.

Embodiments of the present invention provide creators and rightsholders a digital distribution channel with options to monetize content on a wide array of terms of the creators choosing. By automating elements of traditional manual processes, both rightsholders and users can legitimately use content or craft their own individualized copyright licenses at an efficient cost. In addition to facilitating the licensing and use of copyrighted materials that have specified terms and pricing, embodiments of the present invention can identifies public domain material that may be available at no cost to the user. Alternatively, where a royalty-free content is available under certain conditions, such as Creative Commons attribution licenses, the system can provide the digital content at an efficient price (e.g., free).

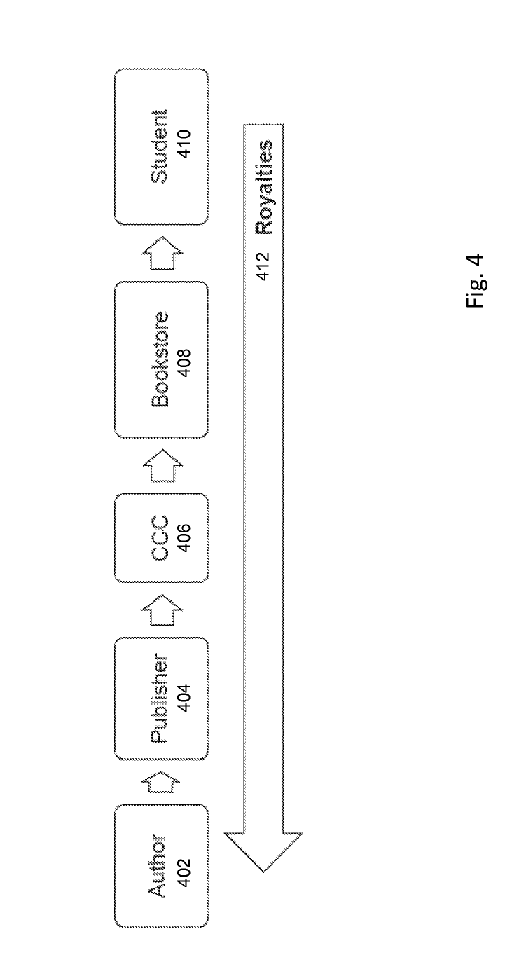

Shown in FIG. 4 is an example of how certain copyrighted book content may flow from author 402 to a consumer such as student 410. As shown, author 402 generates a work such as a book. The author passes the book to his publisher 404 that has the resources to publish the book. Typically the author and the publisher make arrangements for payment terms. The publisher may then pass on the book to copyright clearing center 406 where, again, arrangements are made for payment. Copyright clearing center 406, or other rights clearing center, then makes arrangements with bookstore 408, for example, for distribution of the book to bookstores. Again, arrangements are made for payment. Finally, student 410 may buy the book at the bookstore and make arrangements for payment at the bookstore. Upon purchase of the book by the student, prior art systems for handling books were well-established to then pass on the appropriate royalties 412 back to the author.

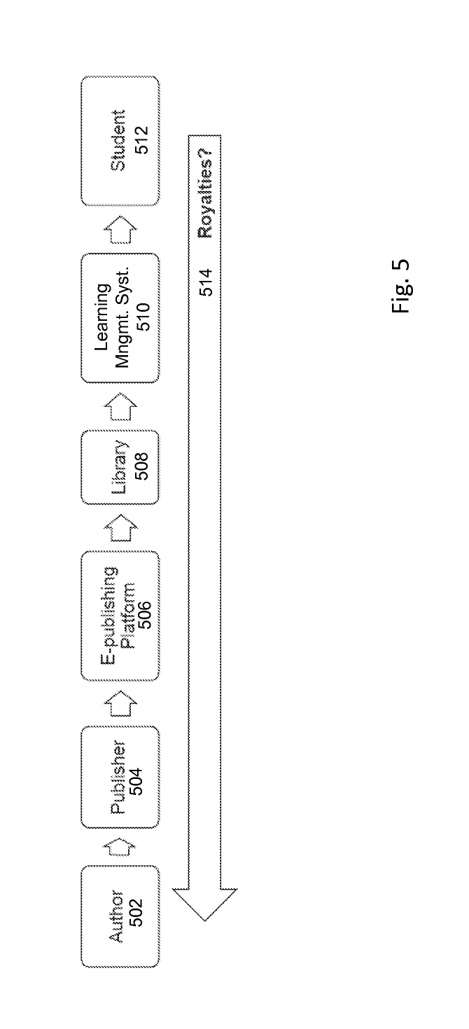

In a more modern situation of digital content, the situation can be more like the one shown in FIG. 5. Indeed, this is only an example because there can be many ways to distribute digital content. As shown in FIG. 5, however, a digital distribution system may include e-publishing platform 506 that can interface directly with library 508 and learning management system 510 for delivering digital content from author 502 to student 512 while passing along the appropriate royalties 514. For example, IEEE publishes much content related to electrical engineering and computer science through it IEEE Xplore platform. Members of IEEE can access the digital content through the Xplore platform, but it is also available to universities through their online library resources such as shown in FIG. 5. Articles of interest can be made available for certain courses where a student may ultimately consume the digital content.

The flow of royalties 514 in the example of FIG. 5 can be unclear, however. For example, prior art systems have not been able to accommodate the situation where a student may be both a member of the university and a member of an organization (e.g., IEEE). Likewise, prior art systems have not been able to pass along royalties in a manner that accounts for these situations.

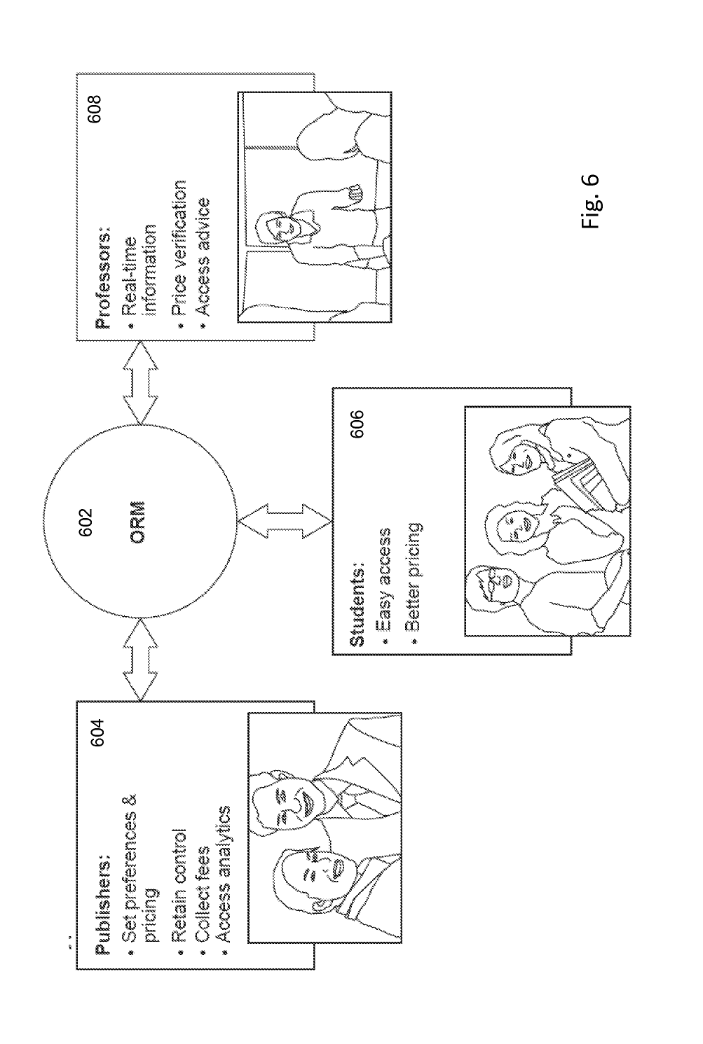

Embodiments of the present invention overcome these and other obstacles by implementing an online rights management system that can account for many situations. For example as shown in FIG. 6 for a university situation, online rights management system 602, according to an embodiment of the present invention, is able to accommodate the needs and desires of publishers 604. In an embodiment, the present invention is able to set preferences and pricing according to the demands of publishers 604 while retaining control of the digital content. An embodiment of the present invention is further able to efficiently collect royalty fees from a consumer such as student 606 while providing the digital content at an efficient price (e.g., lowest price) to a consumer (e.g., student 606). As part of the functionality of the present invention, many details can be tracked so as to provide analytics to publisher 604. In this case where the consumer is, for example, student 606, such student can further be provided with easy access to a broad range of digital content. Also, student 606 may also indicate his preferences for receiving digital content, including his preferences for receiving advertising or other cost subsidies.

In a scenario, professors 608 that may want to use digital content as part of a course are provided valuable guidance and information in an embodiment of the present invention. For example, professor 608 can be provided real-time information about whether the digital content is being consumed and used by his student 606. Also, professor 608 can confirm that the digital content is being provided at an efficient and desirable price. Moreover, professor 608 can be provided advice and information about how to best deliver the digital content. For example, professor 608 can be made aware of licensing programs with universities or organizations. Also, professor 608 can be presented with options for how the price of the digital content can be lowered. For example, advertising options may be able to lower the price. Also, the professor 608 may approve or disapprove of advertising (e.g., cost subsidies) that may be proposed. Indeed, these types of options can also be presented to the end consumer, student 606 in this scenario.

A university situation with a student as a consumer has been presented, however, one of ordinary skill in the art will understand that the present invention has broad applicability that is not limited to a university environment.

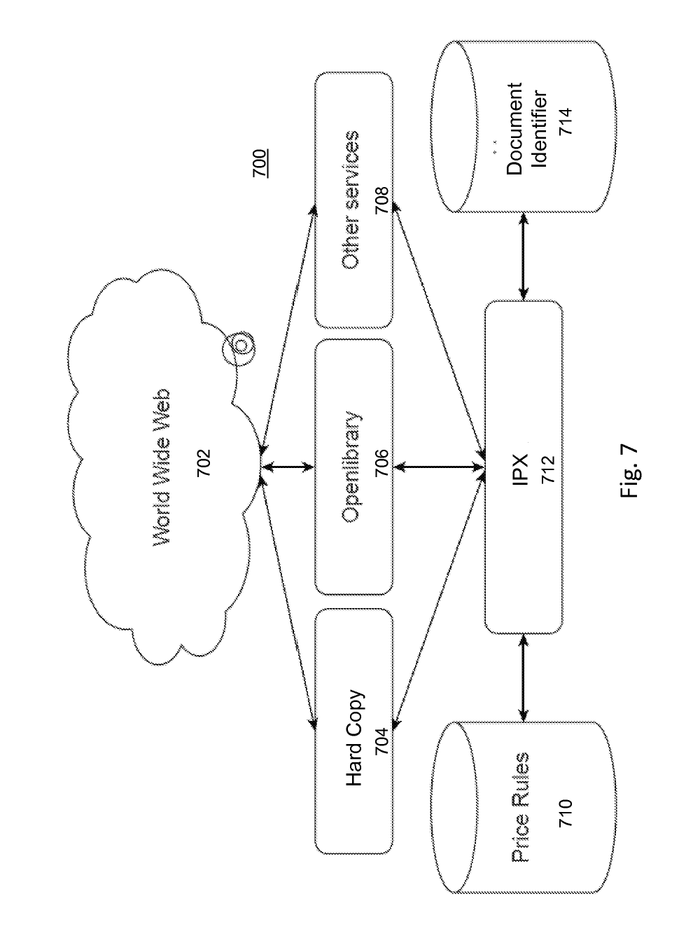

Shown in FIG. 7 is a block diagram 700 of an embodiment of the present invention. As shown in FIG. 7, an embodiment of the present invention is networked through the world wide web 702 so that consumers can access digital content through the internet. As shown, the present invention includes open library module 706 that, among other things, provides for an exchange of information from a consumer to modules within embodiments of the present invention. For example, in an embodiment, open library module 706 is configured to deliver HTML pages to a consumer that present available digital content. In another embodiment of the present invention, a search function is provided to a consumer so as to allow a consumer to find desirable digital content. In this embodiment, open library module 706 is further able to provide lists of digital content that may meet a search criteria. In another embodiment, open library module 706 is able to present many of the services that traditional libraries had previously provided. For example, an embodiment of the present invention provides for virtual browsing of book shelves wherein a user may identify a particular book and browse related books as may be provided in the shelves of a library.

Among other things, open library module 706 is able to communicate with intellection property exchange (IPX) module 712 that is able to account for and manage digital rights in many forms. For example, toward managing digital rights in the many ways, IPX module 712 makes use of price rules database 710 where the many pricing rules for digital content are stored. In contrast to prior art systems that could only accommodate very general rules, the present invention is able to accommodate many manner of rules as may be desired to be implemented by an author or publisher, for example. Through price rules database 710, the present invention is able to account for differences in pricing for a consumer that may, for example, be both a member of a university and an organization (e.g., IEEE) (see example described previously). The functionality of this embodiment of the present invention goes further, however, because price rules database 710 can accommodate much more complex rules. For example, if an author desired to give preferred pricing to his alma mater, price rules database 710 can accommodate such a detail. Indeed, price rules database 710 of the present invention can accommodate many more pricing rules.

In another embodiment, an identification (with inferred or contributed information) is made of a of user's characteristics, behaviors, or preferences for the purpose of determining options to present regarding the best price for the user, which may or may not include cost subsidy messaging (e.g., advertising).

The present invention, through the use of price rules database 710, can further accommodate differential pricing associated with advertising. For example, by passing along choices regarding advertising from the consumer to open library module 706 and IPX module 706, differential pricing rules can be applied as stored in price rules database 710.

As shown in FIG. 7, hard copy module 704 is provided in an embodiment of the present invention that delivers customized hard copies generated from digital content. In an embodiment, choices regarding its construction can be made by a consumer that affect the pricing of the hard copies. For example, where a choice is made to receive advertising, the customized hard copy can be generated with advertising so as to provide the hard copy at a lower price. Many other options can be implemented as would be known to one of ordinary skill in the art.

The advertising that can be included in embodiments of the present invention can be of high value because it can be made targeted. For example, where a course reader is being made for a medical school class, targeted advertising directed at medical students can be included. In this way, an advertiser can be assured that his message is reaching exactly the audience he desires. In this situation, an advertiser could be willing to pay a much higher price for having his advertising placed in a desirable location. Those of ordinary skill in the art will understand the many further benefits associated with advertising that can be delivered according to embodiment of the present invention.

Digital media can be delivered to a consumer in many other ways as known to those of ordinary skill in the art. Accordingly, other services module 708 can be provided for alternatively delivering content to a consumer. For example, in an embodiment, a digital course reader is generated that can be read using a Kindle, iPad, or other digital device, including a computer.

In an embodiment, IPX module 712 manages price rules database 710 along with the digital content (e.g. documents) and the associated transactions. In an embodiment, IPX module 712 delivers documents from a document repository to an end consumer. In another embodiment, IPX module 712 maintains information (e.g., a IPX identifiers) about where the digital documents reside anywhere on the World Wide Web and delivers the documents to a consumer by means of a hyperlink. In an embodiment, such a hyperlink is implemented in HTML code. In an embodiment of the present invention, document identifier database 714 maintains information about where a document may reside. In this embodiment, the present invention need not be burdened with maintaining the required hardware resources and can instead rely on the resources from a digital publisher, for example. Instead, an embodiment of the present invention provides a link to a third party repository of the desired content.

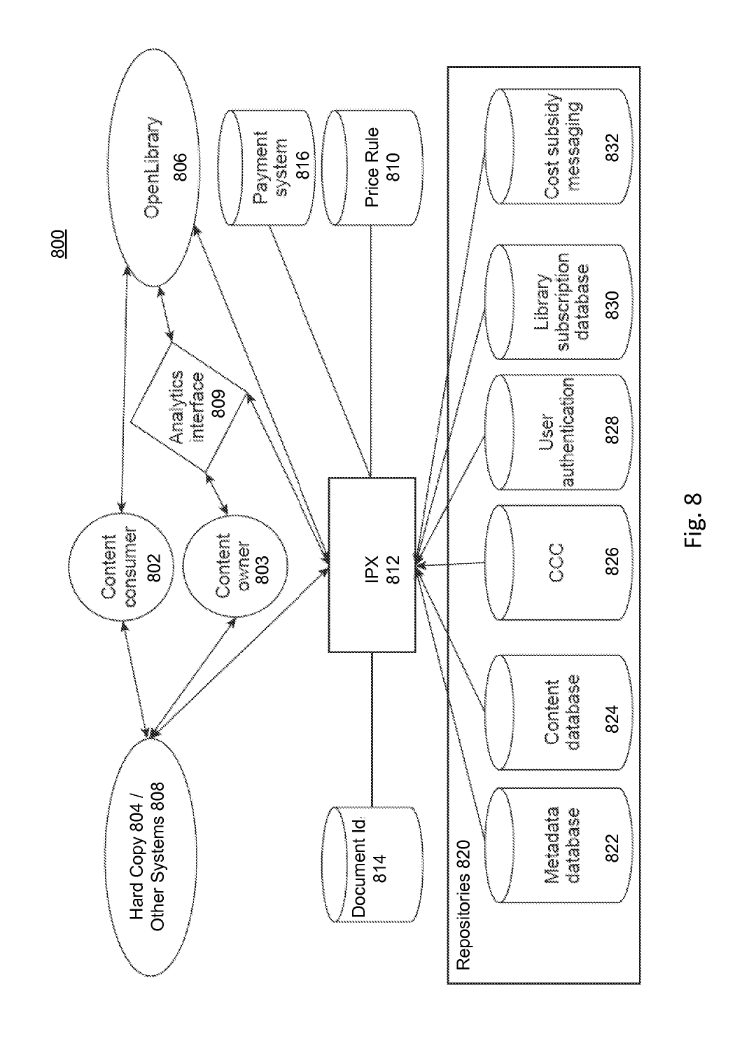

Shown in FIG. 8 is block diagram 800 of another embodiment of the present invention. Note, however, that the present invention is not limited to any one embodiment. Indeed, embodiments of the present invention can include different combinations of features as provided in the present disclosure and as would be understood by one of ordinary skill in the art upon understanding the present disclosure.

As shown in FIG. 8, an embodiment of the present invention is able to connect the needs of content consumer 802 with the digital works of content owner 803. For example, content consumer 802 may be a doctoral student that would like to identify scholarly articles related to his research. Among other things, embodiments of the present invention are able to efficiently communicate the needs of consumer 802 to electronically retrieve desired works from content owner 803 at an efficient price, preferably the lowest possible price.

As part of the present disclosure, it should be noted that communication amongst the various entities may be done through various means including, for example, networked connections. Networked connections can be local network connections such as through a local area network. Alternatively, networked connections can be made across wide area networks that may include the Internet. Other embodiments, provide networked connections in mixed local and wide area networks that include the Internet.

As shown in FIG. 8, the present invention includes open library module 806 that, among other things, provides for an exchange of information from a consumer to modules within embodiments of the present invention. For example, in an embodiment, open library module 806 is configured interface with content consumer 802 and to deliver HTML pages to content consumer 802 that present available digital content, for example on an electronic display. In another embodiment of the present invention, a search function is provided to content consumer 802 so as to allow content consumer 802 to find desirable digital content.

In an embodiment of the present invention, open library module 806 is further configured to communicate with analytics interface module 809 so as to collect and generate statistics that may be useful, for example, to content owner 803. Compiled information and statistics from large collections of content consumers 802 as generated from analytics module 809 can, for example, be stored in IPX module 812. Because privacy can be a big concern, an embodiment of the invention scrubs identifying information from any analytics or statistics that may be generated and collected. Indeed, aggregate information is generally anonymous but an embodiment of the invention, nonetheless, deletes all identifying information from the collected information so as to avoid potential problems.

Open library module 806 is further able to provide lists of digital content that may meet a search criteria. In another embodiment, open library module 806 is able to present many of the services that traditional libraries had previously provided. For example, an embodiment of the present invention provides for virtual browsing of book shelves wherein a user may identify a particular book and browse related books as may be provided in the shelves of a library.

Among other things, open library module 806 is able to communicate with intellection property exchange (IPX) module 812 that is able to account for and manage digital rights in many forms. For example, toward managing digital rights, IPX module 812 makes use of price rules database 810 where the many pricing rules for digital content are stored. In contrast to prior art systems that could only accommodate very general rules, the present invention is able to accommodate many types of rules as may be desired to be implemented by content owner 803, for example. Through price rules database 810, the present invention is able to account for differences in pricing for a consumer that may, for example, be both a member of a university and an organization (e.g., IEEE) (see examples described previously). The functionality of this embodiment of the present invention goes further, however, because price rules database 810 can accommodate much more complex rules. For example, if an author desired to give preferred pricing to his alma mater, price rules database 810 can accommodate such a detail. Indeed, price rules database 810 of the present invention can accommodate many more pricing rules.

In an embodiment of the present invention, IPX module 812 further interfaces with payment system 816. In an embodiment, upon a determination of an efficient price (e.g., a lowest price) for a digital work, IPX module 812 interfaces with payment system 816 so as to facilitate an exchange of money or royalty from content consumer 802 to content owner 803. IPX module 816 in conjunction with payment system 816 is further able to facilitate payments to other entities. For example, an embodiment of the present invention provides value to content consumer 802 and content owner 803. Accordingly, an embodiment of the present invention facilities the payment of the owner or facilitator of the intellectual property exchange system.

In an embodiment of the present invention, license and copyright information are codified and recorded in price rules database 810, for example. Embodiments of the present invention are flexible and agile in that they can accommodate a wide range of license and copyright provisions. For example, in an embodiment, predetermined rule formats are provided that generally accommodate a wide range of licenses and copyright provisions. The present invention, however, is able to accommodate unique or less common provisions. Generally, where a license or copyright provision can be codified and authenticated, preferably automatically, embodiments of the present invention can implement the provision. In an embodiment, the process of codifying a copyright license includes extracting relevant data from legal documents at varying levels of legal sophistication.

A database of rules according to embodiments of the present invention captures many different types of situations, including but not limited to:
identifying public domain content (e.g., when a work is in the public domain and can be freely used by every user with no royalty payment);
identifying creative commons and royalty-free conditional use content (e.g., when a work can be used under certain conditions with no royalty payment, depending on the user's desired activity, such as if an author does not want to charge royalties for users seeking to use his research paper for educational purposes, but will charge royalties for users seeking commercial use);
identifying pre-existing subscription or licensed content (e.g., when a subscription has been purchased on behalf of certain users, for certain rights to certain materials, such as if a school library purchased subscription access to a journal database on behalf of its students and professors, which may or may not include the right for professors or students to copy the subscription materials into course readers).

Embodiments of the present invention are designed to scale and grow as documents, or other digital content, and their associated rights are added to the system. For example, pre-existing rights and large volumes of documents or digital content can be incorporated from organizations such as Creative Commons, an organization that helps creators attach limited conditions of use to their works. For example, one type of Creative Commons license only requires that attribution be credited to the creator, and no royalty fee payment is necessary. In an embodiment, a user interface is provided to content consumer 802 or content owner 803, for example through open library 806 or other systems 808, tools so that participants can add and update their own existing subscription agreements and licenses in the price rules database.

In an embodiment of the present invention, when a request for copyright clearance is provided to IPX module 812, a query is made of price rules database 810 to determine whether the intended user already has rights needed to use the requested content and activity. In this way, the present invention can be user-centric by dynamically filtering for pre-existing applicable licenses. If a determination is made that the user needs further permissions that are not recorded in its price rules database 810, IPX module 812 communicates to the user the pricing and licensing conditions under which the copyright owner is willing to grant those necessary permissions.

IPX module 812 can efficiently provide these automated and dynamic royalty fee calculations to users because IPX module 812 also provides an improved interface by which content owners can register licensing terms and conditions for their works. In a similar way in which pre-existing licenses are recorded, a content owner's licensing preferences and pricing can also be recorded, which allows content owners to capture previously unavailable or cost-prohibitive streams of revenue. For example, because of the flexibility of embodiments of the present invention, content owners may be able to provide the works in manners not previously contemplated because it was not previously possible.

One manner of doing this is by allowing a content owner to separate or bundle content in different forms. Where book may contain sever chapters, for example, a content owner may find it desirable and profitable to sell his chapters separately. A potential benefit is that a content consumer is able to get only that content that interests him without having to pay content that does not interest him. As an example, where a consumer may not want to purchase a 10 chapter book for $100, he may be interested at buying a particularly interesting chapter for $15. In certain ways, this is an efficient result because the consumer has spent less money but the content owner has received some revenue where he may not otherwise get any.

In an embodiment of the present invention, the final purchase transaction, with dynamically calculated royalty pricing, is facilitated through IPX module 812 through a communicatively coupled distribution platform such as payment system 816. Embodiments of the present invention provide real-time royalty calculation of pricing wherever possible.

In yet another embodiment of the present invention advertising can be presented to content consumer 802 at various stages of usage of the system by content consumer 802. For example, where search functionality is provided by open library module 806 to the content consumer, advertising can be presented to content consumer 802. In an embodiment, the presented advertising is based on the search terms entered by content consumer 802. In another embodiment, advertising is presented according to a predetermined schedule. In still another embodiment, advertising is presented based on information about content consumer 802, such as his status as a student or a professional. Many other schemes can be implemented for providing advertising to content consumer 802 based on search criteria as is known to those of ordinary skill in the art.

In an embodiment of the present invention, advertising revenue is managed by IPX module 812 in conjunction with payment system 816. For example, IPX module 812 in conjunction with payment system 816 monitors the advertising presented to content consumers 802 and arranges for payments from the advertiser.

In an embodiment of the present invention, advertising is presented as an opt-in condition. For example, at a start of a session by content consumer 802 or through user-specific settings for content consumer 802 a selection can be made to opt-in to advertising in exchange for a reduced price of the desired digital content. In situations, where an advertiser can identify a desirable content consumer, high-value and predetermined advertising can be channeled to content consumer 802. For example, in a situation where content consumer 802 is identified as a medical student that opts in to advertising, potential advertisers will be willing to pay a higher price for such targeted advertising. Where content consumer 802 is a medical student, he may desire to reduce the price of digital content because he is on a limited budget, but an advertiser of medical equipment, for example, would be eager to target their advertising to such content consumers and would be willing to pay a higher price for such advertising.

In yet another embodiment of the present invention, content consumer 802 is able to provide a detailed profile of the type of advertising he is willing to receive as well as identify advertising he is not willing to receive. In this way, for example, embodiments of the present invention, through the use of price rules database 810, can accommodate differential pricing associated with advertising. For example, a medical student may be willing to receive adverting about medical equipment, but for personal reasons may not be willing to receive advertising about expensive luxury items such as cars or jewelry. Whereas an advertiser of luxury items may seek to target medical students that could become consumers of expensive luxury items, such a selection by content consumer 802 is, nonetheless, valuable to the advertiser. For example, the advertiser of the luxury items need not waste his advertising budget on content consumer 802 that is not receptive to his advertising or his products.

In other embodiments of the present invention, IPX module 812 in conjunction with payment system 816 and analytics interface module 809 is able to collect, generate, and manage usage information about content consumers 802, content owner 803, and/or retrieved documents or digital content so as to provide targeted and high value advertising to content consumer 802. For example, an embodiment of the present invention is able to anonymously manage content consumer 802 information so as to direct targeted information to content consumer 802 while not revealing personal information about content consumer 802. In another embodiment, locale information is anonymously managed to provide groups of content consumers 802 with targeted information. For example, an embodiment of the present invention is able to identify a locale based on IP addresses. In such a situation, while more personal information may not be used, locale information may, nonetheless, be valuable to an advertiser. For example, an IP address may correspond to a university, targeted advertising can be provided. Other locale information can be obtained as would be known to those of ordinary skill in the art.

As shown in FIG. 8, hard copy module 804 is provided in an embodiment of the present invention that delivers customized hard copies generated from digital content. In an embodiment of the present invention, an interface is provided to content consumer 802 for constructing a hard copy document. For example, content consumer 802 can electronically gather documents or other digital content and arrange them as desired to be printed. In an embodiment of the present invention, hard copy module 804 provides for printing and binding of a hard copy document as arranged by content consumer 802. In another embodiment, a third-party entity (not shown) can generate a collection of documents or other digital content that content consumer 802 can generate as a hard copy through hard copy module 804.

In yet another embodiment, choices regarding the construction of a hard copy can be made by a consumer that affect the pricing of the hard copies. For example, where a choice is made to receive hard copy advertising, the customized hard copy can be generated with advertising so as to provide the hard copy at a lower price. Pricing can also be affected by consumer-specific selections, subsidies, and offsets provided by the potential advertisers. Many other options can be implemented based on the advertising schemes described herein and as would be known to one of ordinary skill in the art.

Digital media can be delivered to a consumer in many other ways as known to those of ordinary skill in the art. Accordingly, other services module 808 can be provided for alternatively delivering content to a consumer. For example, in an embodiment, a digital course reader is generated that can be read using a Kindle, iPad, or other digital device, including a computer.

In an embodiment, IPX module 812 manages price rules database 810 along with the digital content (e.g. documents) and the associated transactions. In an embodiment, IPX module 812 delivers documents or other digital content from a content repository to an end consumer. In another embodiment, IPX module 812 maintains information (e.g., IPX identifiers) about where the digital content reside anywhere on the Internet and delivers the content to a consumer by means of a link (e.g., a hyperlink). In an embodiment, such a hyperlink is implemented in HTML code. In an embodiment of the present invention, document identifier database 814 maintains information about where a document or other digital content may reside. In this embodiment, the present invention need not be burdened with maintaining the required hardware resources and can instead rely on the resources from a digital publisher, for example. Instead, an embodiment of the present invention provides a link to third party repositories 820 that maintain the desired content.

In an embodiment of the present invention, IPX module 812 maintains document identifier database 814 that includes information about documents or other digital content contained within repositories 820. For example, as documents or other digital content are added to the system, a unique IPX identifier is associated with such documentor other digital content as well as information about where the document or other digital content is maintained. Examples of repositories 820 include content database 824 that may be a privately maintained database of documents such as an IEEE database or other database of scholarly journals. Repositories 820 may also include a copyright clearance center database 826, or other rights database, that maintains documents for collections of content owners 803.

Still other respositories 820 include repositories of information that can be used by IPX module 812 in identifying an efficient price for a document or other digital content. For example, user authentication database 828 can be used to identify content consumer 802 as belonging to an organization for which there exists favorable pricing. Also, IPX module 812 can utilize information maintained by a library subscription database 830 to determine, for example, whether a particular content owner 802 has privileges to a library that, in turn, has rights to particular documents or other digital content.

Also, IPX module 812 may interface with cost subsidy messaging database 832 to determine whether content consumer 802 may benefit from cost subsidies such as provided by advertisers as discussed herein. In still another embodiment, IPX module 812 interfaces with repositories 820 to identify documents or other digital content that may be desired to be retrieved. For example, metadata database 822 may contain metadata about documents or other digital content that assist a content consumer in identifying a desirable document or other digital content. Metadata may include document identifying information such as title, author, date, publisher, and abstract information.

Other repositories 820 can be implemented based on the teachings of the present disclosure and as would be known to those of ordinary skill in the art. For example, another repository may include a User Preferences repository that assists in the identification (with inferred or contributed information) of a of user's characteristics, behaviors, or preferences for the purpose of determining options to present regarding the best price for the user, which may or may not include cost subsidy messaging (e.g., advertising). Alternatively, such user preferences can be incorporated in user authentication database 828 to identify the rights of users among other things.

Rules, including price rules, are associated with each document or other digital content and maintained within price rules database 810 according to an embodiment of the present invention. An advantage of the present invention is that price rules database 810 is flexible. Whereas prior art price rules databases may have a fixed number of pricing criteria, embodiments of the present invention employ price rules database 810 with a wide range of pricing criteria. Still another embodiment of the present invention provides a mechanism for implementing unique pricing criteria as may be desired by content owner 803. In implementing a wide range of pricing criteria, it can be expected that price rules database will be sparse in its content. Price rules database 810 can, therefore, be managed accordingly. For example, an embodiment of the present invention implements compression techniques to efficiently manage the space required to implement price rules database 810. Still other techniques as would be known to those of ordinary skill in the art can be implemented in managing price rules database 810.

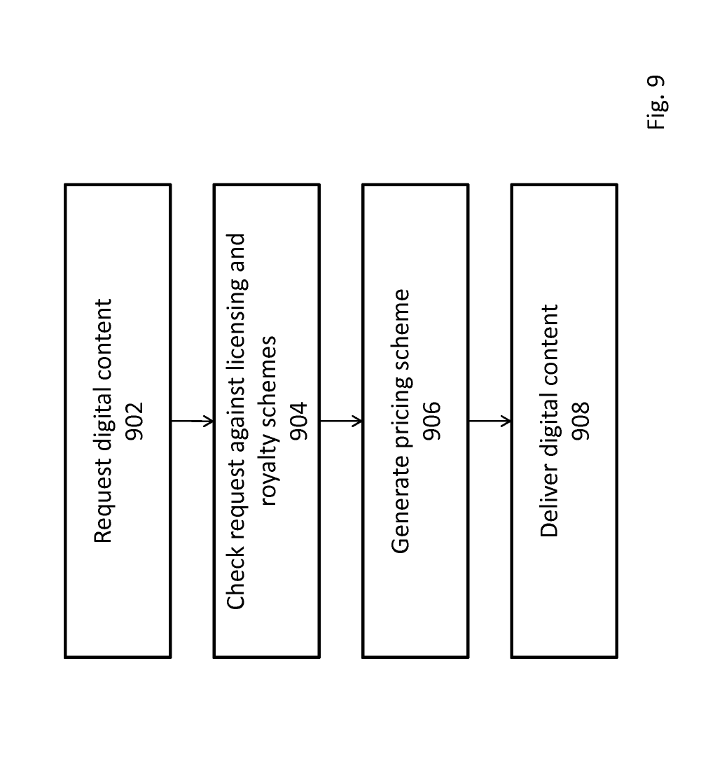

Shown in FIG. 9 is a method according to an embodiment of the present invention for delivering digital content to a content consumer. In the discussion to follow certain features will be described, but it should be appreciated that the many features discussed above can also be implemented into the method of FIG. 9 as other embodiments of the present invention.

As shown, at step 902, a content consumer generates a request for digital content. In an embodiment, a user inputs general identifier or search criteria (e.g., title, article, publisher, etc.) for desired content to pinpoint IPX identifier. In other embodiments, this input can be performed through a third party platform or directly through open library module 806 or other system 808.

At step 904, the requested content is checked against available licenses and pricing rules as maintained in price rules database 810, for example. Among other things, a query can be made as to whether the content requires royalty payments or has other conditions attached to it. Rules can be checked such as whether the digital content is in the public domain, or whether a user has existing rights to the digital content. Many other queries and checks can be made as described herein and as would be understood by those of ordinary skill in the art.

At step 906, the various pricing rules for a digital document or other digital content are used to generate a pricing scheme for a content consumer. In an embodiment, the digital content is presented at an efficient price such as the lowest possible price. In yet another embodiment, options can be presented to a consumer for receiving the digital content at different prices. For example, an option can be provided for receiving the digital content along with advertising. In yet another embodiment, options can be provided for exploring other pricing options that, to this point, have not been fully defined. For example, further information may be required from a consumer to determine whether certain discounts may apply. They can be input and a more refined pricing scheme can be presented. Many other alternatives are possible as described herein and as would be understood by those of ordinary skill in the art.

At step 908, the desired digital content is delivered to the consumer. In an embodiment, it is delivered from a local repository. In another embodiment, it is delivered from a remote repository. In an embodiment, the digital content is delivered at a price that accounts for differential pricing rules. The present invention, therefore, allows different users to receive digital content with differential pricing. Many other alternatives are possible as described herein and as would be understood by those of ordinary skill in the art.

Embodiments of the present invention were presented with reference to written works, but it should be understood that the teachings of the present invention are applicable to other works. For example, embodiments of the present invention can be implemented to manage rights associated with music, visual arts, software, and applications. Many other applications are possible as would be understood by those of ordinary skill in the art.

Embodiments of the present invention were presented with reference to copyrights, but it should be understood that the teachings of the present invention are applicable to other rights. For example, embodiments of the present invention can be implemented to manage trademarks or trade secrets. Instead of delivering digital content to which copyrights may be attached, such an alternative embodiment can deliver digital content to which trademarks or trade secrets may be attached.

Still other embodiments of the present invention can be implemented to manage patent rights (e.g., trade secret circuit designs). For example, instead of deliver digital content to which copyrights may be attached, such an alternative embodiment can deliver digital content to which patents may be attached (e.g., patented software). Indeed, embodiments of the present invention provide an efficient manner by which to connect a content consumer to a content owner where legal rights to the content need to be considered in the transaction.

Another embodiment of the present invention is able to interface with a learning management system (LMS), where an LMS is a software application or platform for the administration, documentation, tracking, and reporting of training programs, classroom and online events, e-learning programs, and training content. Many universities and other institutions have incorporated LMS into their organizations. Through an application program interface (API), for example, embodiments of the present invention can communicate and interface with and LMS to manage rights associated with digital works. LMS is used for electronically planning, delivering, and managing learning events within an organization, including online, virtual classroom, and instructor-led courses. The focus of an LMS is to manage students, keeping track of their progress and performance across all types of training activities. It also performs administrative tasks, such as reporting to instructors, HR and other ERP systems. The functionality of embodiments of the present invention are, therefore, a natural complement to an LMS.

Still other embodiments can interface with virtual learning environments (VLE) especially where the VLE desires to distribute digital content to its users. VLEs are used by universities and colleges, for example, to allow instructors to electronically manage their courses and exchange information with students for a course. An API, for example, can interface embodiments of the present invention with VLEs.

It should be appreciated by those skilled in the art that the specific embodiments disclosed above may be readily utilized as a basis for modifying or designing other image processing algorithms or systems. It should also be appreciated by those skilled in the art that such modifications do not depart from the scope of the invention as set forth in the appended claims.

What is claimed is:

1. A computer-implemented method for delivering digital content comprising:
receiving a request for digital content from a client;
retrieving rights associated with the client;
retrieving at least two licensing terms for the digital content;
determining at least one price for delivering the digital content to the client based on the retrieved at least two licensing terms; and
arranging for delivery of the digital content to the client.

2. The computer-implemented method of claim 1, wherein the rights are copyrights.

3. The computer-implemented method of claim 1, wherein the digital content is a written work.

4. The computer-implemented method of claim 1, wherein the digital content is an audio work.

5. The computer-implemented method of claim 1, wherein the digital content is a visual work.

7. The computer-implemented method of claim 1, wherein the digital content is a software application.

8. The computer-implemented method of claim 1, wherein the price is a lowest price.

9. The computer-implemented method of claim 1, further comprising arranging for payment by the client.

10. The computer-implemented method of claim 1, further comprising receiving an indication for selecting a first price from the at least one price.

11. The computer-implemented method of claim 1, further comprising providing a link to the client for retrieving the digital content from a repository.

12. The computer-implemented method of claim 1, further comprising delivering the digital content to the client from a repository.

13. The computer-implemented method of claim 1, further comprising compiling analytics about the request for digital content and the client.

14. A computer-readable medium including instructions that, when executed by a processing unit, cause the processing unit to implement a method for delivering digital content, by performing the steps of:
receiving a request for digital content from a client;
retrieving rights associated with the client;
retrieving licensing terms for the digital content;
determining at least one price for delivering the digital content to the client; and
arranging for delivery of the digital content to the client.

15. The computer-readable medium of claim 14, wherein the rights are copyrights.

16. The computer-readable medium of claim 14, wherein the digital content is a written work.

17. The computer-readable medium of claim 14, wherein the digital content is an audio work.

18. The computer-readable medium of claim 14, wherein the digital content is a visual work.

19. The computer-readable medium of claim 14, wherein the digital content is a software application.

20. The computer-readable medium of claim 14, wherein the price is a lowest price.

21. The computer-readable medium of claim 14, further comprising arranging for payment by the client.

22. The computer-readable medium of claim 14, further comprising receiving an indication for selecting a first price from the at least one price.

23. The computer-readable medium of claim 14, further comprising providing a link to the client for retrieving the digital content from a repository.

24. The computer-readable medium of claim 14, further comprising delivering the digital content to the client from a repository.

25. The computer-readable medium of claim 14, further comprising compiling analytics about the request for digital content and the client.

26. A computing device comprising:
a data bus;
a memory unit coupled to the data bus;
at least one processing unit coupled to the data bus and configured to receive a request for digital content from a client;
retrieve rights associated with the client;
retrieve licensing terms for the digital content;
determine at least one price for delivering the digital content to the client; and
arrange for delivery of the digital content to the client.
